(19) United States
(12) Patent Application Publication
(10) Pub. No.: US 2018/0319641 A1
(43) Pub. Date: Nov. 8, 2018

(54) PROTECTIVE DEVICE FOR A FORKLIFT

(71) Applicant: FORK POINT AS, Øyestranda (NO)

(72) Inventors: Torliev EFTESTØL, Øyestranda (NO); Owen R. OMLAND, Kvinesdal (NO)

(21) Appl. No.: 15/773,683

(22) PCT Filed: Nov. 8, 2016
(86) PCT No.: PCT/NO2016/050221

§ 371 Date: May 4, 2018

(30) Foreign Application Priority Data
Nov. 10, 2015 (NO) 20151534

(51) Int. Cl. B66F 9/075; B66F 17/00

(52) U.S. Cl. CPC B66F 9/0755; B66F 9/12; B66F 17/003

(57) ABSTRACT

A protective device (1) for a forklift comprises a sensor (11) at a front face (21) of a fork (20) and a cable (12) running from the sensor (11) along the fork (20) to a controller (17). The sensor (11) is arranged in a recess (10) in a wear plate (13) welded or glued to the fork (20).

### BACKGROUND

### Field of the Invention

The invention relates to a protective device for a forklift.

### Prior and Related Art

When a forklift approaches a pallet, there is a risk that the fork misses the pallet openings and damages goods on the pallet during loading. If the pallet is stored in a rack, there is an additional risk that the pallet or a pallet behind it is pushed out of the rack, e.g. by a fork during loading or a pallet during unloading. This increases the risk for damage to the goods and injury for those working in the warehouse.

DE9210314U1 attempts to solve this problem by providing a light-source and a light-detector in a fork-tip, i.e. the end opposite the mast of the forklift. Optical fibres extend from a controller at the fork end close to mast to the light-source and detector at the tip. The light-source and detector faces upward. If the light source is under a pallet, the detector detects refracted light from the light source. If the light source, i.e. the free end of the forks, is outside the pallet openings, the detector senses no refracted light, and the controller decides whether the fork-tips are extended too far, or if the fork-tips are still not inserted into the pallet openings. However, during unloading, the fork-tip is typically placed under the pallet. Then, no light is refracted to the detector, so the device cannot detect if the fork is extended too far.

NO332897b1 discloses a sensor device configured to detect solid material, and to indicate a vertical distance between a fork-tip and the solid material. The sensor device is disposed in a releasable holder configured to fit around the fork-tip, and communicates with a signal-processing unit remote from the sensor device. One problem with this device is that the holder must be properly secured to the fork-tip so it does not fall off. Simpler solutions in which a sensor at the fork-tip is wired to a controller is known from e.g. JP2003063793.

A problem with the above solutions is that the forks are prone to wear. This is particularly critical in the fork-tip with a sensor, as the sensor may be damaged and stop functioning. Other problems are associated with the type of sensor. For example, a mechanical contact sensor may be damaged by mechanical shocks, e.g. caused by a small collision, and/or dust preventing a moving element from moving. An optical sensor may stop working if its light source and/or light sensitive surface is covered with dust.

The main objective of the present invention is to remove or reduce at least some of the problems above while retaining the benefits of prior art.

### SUMMARY OF THE INVENTION

This is achieved with a device according to claim 1.

More particularly, the invention provides a protective device for a forklift, comprising a sensor at a front face of a fork and a cable running from the sensor along the fork to a controller. The controller can send information to a display unit mounted on the dash board in combination with a signalling lamp and or an alarm. The operator will then have necessary information. The sensor is arranged in a recess in a wear plate attached to the fork.

The wear plate combines hardness and toughness, i.e. the ability to withstand abrasion with the ability to absorb energy without fracturing. This protects the sensor.

In a preferred embodiment, the wear plate is configured to cover the upper surface of the fork. In this embodiment, the wear plate may extend the working life of the fork.

In a further preferred embodiment, the wear plate is divided into several sections by lateral cuts. Thereby, the protective device may be conveniently stored and transported as a kit of sections that are easily mounted together with the sensor and cable on site. One section may be cut on-site such that the kit fits forks of different length.

If the wear plate covers the upper surface of the fork, a longitudinal recess is preferably provided in the wear plate to enclose the sensor and cable.

In an alternative embodiment, the cable runs in a longitudinal groove in the fork. The groove may be milled on-site, and should be just deep enough to receive the cable. Milling a shallow groove hardly affect the strength of the fork.

In both embodiments, the wear plate preferably covers the cable for additional protection. In embodiments with a recess in the wear plate adapted to fit on an upper surface of the fork, this implies that the recess is provided in a bottom surface that will be covered by the wear plate when mounted. In embodiments with a milled groove, the wear plate most likely increases the strength of the fork.

Regardless of the configuration of sensor and cable, the sensor is preferably an optical source and detection unit, as such units are reliable and functional for the purpose. In particular, they do not need a bulky amplifier close to the detection unit, and are thus easy to fit near the fork-tip.

The optical sensor preferably operates in the infrared range. This reduces the sensitivity for dust covering the optical source and/or detector.

If the sensor is an optical sensor in the visible or infrared spectrum, the cable preferably comprises an optical fibre. Alternatively or in addition, the cable might comprise a wire conducting electrical power to, for example, an LED-source.

### BRIEF DESCRIPTION OF THE DRAWINGS

The invention will be described in greater detail by means of examples and with references to the drawings, in which:

FIG. 1 is a section through a fork with a protective device according to the invention;

FIG. 2 is a bottom view of the protective device;

FIG. 3 illustrates an embodiment in the form of a kit;

FIG. 4 shows a fork for a forklift with a device according to the invention;

FIG. 5a shows a partly sectioned fork-tip viewed from a side;

FIG. 5b shows the fork-tip of FIG. 5a with an additional wear plate;

FIG. 6a shows a fork-tip with a wear plate on part of its top face;

FIG. 6b is a top view of the embodiment in FIG. 6a;

FIG. 7a is a front view of a fork-tip and

FIG. 7b shows an alternative to the fork-tip in FIG. 7a.

### DETAILED DESCRIPTION OF A PREFERRED EMBODIMENT

The drawings are schematic and not necessarily to scale. For ease of understanding, numerous details know to one skilled in the art are omitted from the drawings and the following description.

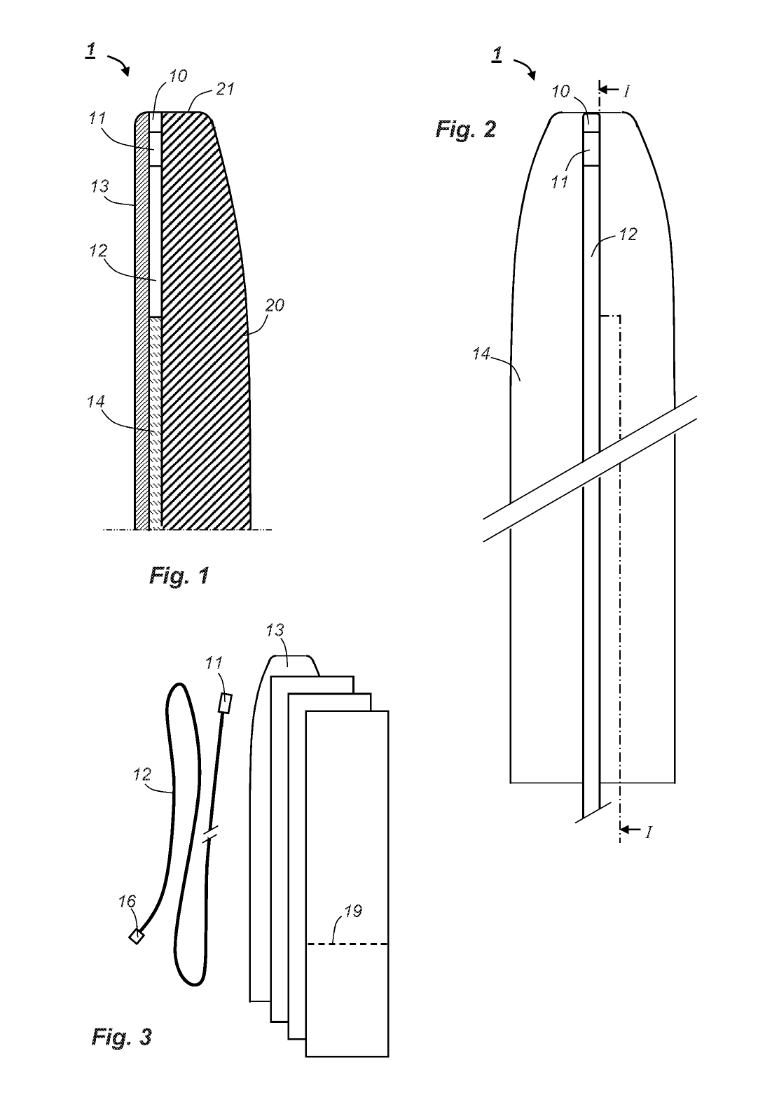

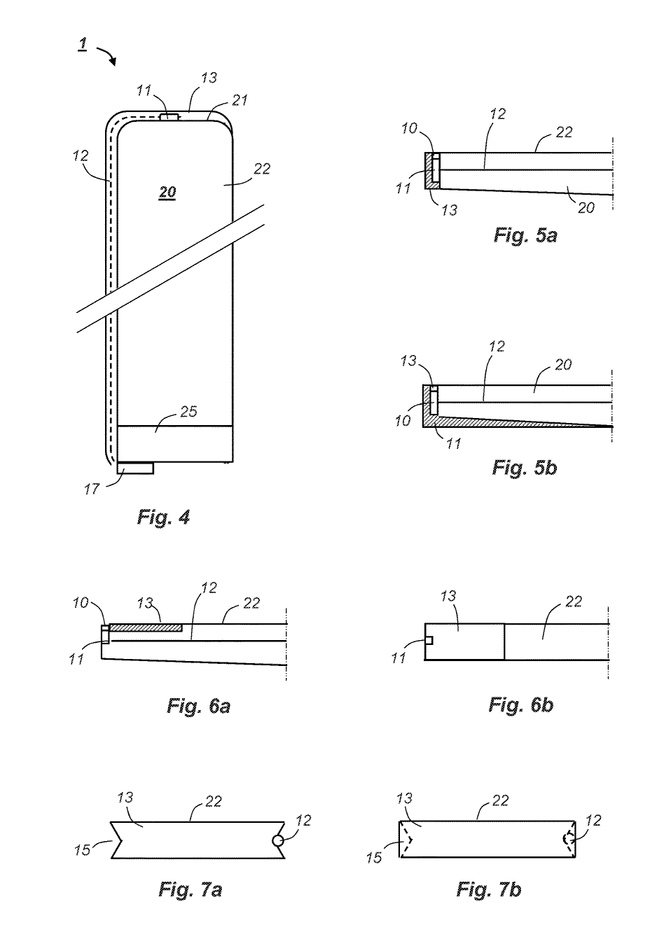

FIG. 1 shows a fork 20 for a forklift with a protective device 1 according to the invention. More particularly, FIG. 1 is a section along cut I-I in FIG. 2. The cut I-I is along two separate planes. The first plane runs along the edge of a recess 10, and corresponds to the upper half of FIG. 1. A sensor 11 is arranged within the recess 10 at a tip 21 of fork 20 for a forklift. The sensor 11 is connected to a cable 12, which is also disposed in the recess 10. The cable 12 transmits power and/or communication between the sensor 11 and a controller (17; FIG. 4)

The wear plate 13 should combine hardness and toughness. Hardness, also called yield strength or tensile strength, is the property that prevent the edges of abrasive material to cut into the surface. Toughness is the ability of a material to absorb energy without fracturing. Steels that combine hardness and toughness and that may be cut, milled and welded are commercially available, e.g. as Hardox wear plates from SSAB of Sweden. These wear plates may be cut and welded without losing their hardness and toughness. Alternatively, the wear plate may be manufactured from any other suitable material, e.g. another steel or fibre-reinforced plastic, or from a combination of plastic and steel. If the wear plate 13 is made of Hardox, we believe that plate thicknesses of 4 mm or less are sufficient.

The second plane of the cut I-I runs through a layer 14 fixed to the wear plate 13 on each side of the recess 10 as shown in the lower half of FIG. 1. The layer 14 is shown separately for illustration only, and may be part of the wear plate 13. For example, the recess 10 may be a longitudinal recess milled into the wear plate. Alternatively, the layer 14 may comprise longitudinal pieces of reinforced plastic or another suitable material glued or welded to the wear plate 13 with a distance between them to form the recess 10.

FIG. 2 shows the bottom face of the protective device 1, i.e. the face that will contact the upper face of the fork 20 when the protective device is mounted. The sensor 11 is retracted from the tip, and will be protected by the wear plate 13 above and fork 20 below when mounted.

FIG. 3 illustrates a preferred embodiment of the protective device 1, which is stored and transported as a kit comprising several sections of wear plates 13 provided with a recess 10 (not shown in FIG. 3). Together, the sections match the shape of the fork, and each section 13 may be, for example, 30-50 cm long. The section to be mounted closest to the mast of the forklift may be cut to fit as indicated by the dotted line 19. Thereby, one kit may be adapted to forks of different length, but of similar width and shape.

Cuts parallel to the dotted line 19 are called “lateral cuts” in the claims, as they are perpendicular to the longitudinal direction along the wear plate 13, and to the fork 20 when the protective device is mounted.

The cable 12 with a sensor 11 in one end and a contact 16 for the controller shown in FIG. 3 belongs to the kit, and will be mounted as described with reference to FIGS. 1 and 2. The entire assembly of sensor 11 and cable 12 covered by wear plate 13 will be attached, e.g. welded or glued, to the upper surface of the fork.

FIG. 4 illustrates a second embodiment of the device 1 mounted on a fork 20. A sensor 11 at the front face 21 is protected by a wear plate 13, and a cable 12 runs from the sensor 11 to a controller 17 along the fork 20. The sensor 11 is arranged in a recess in the wear plate 13 attached to the fork 20. Contrary to the first embodiment shown in FIGS. 1-3, a wear plate does not cover the upper surface 22 of the fork 20 in FIG. 4.

The fork 20 comprises a vertical part 25 for attaching the fork 20 to the mast of a forklift in a customary manner. The controller 17 is shown at a protected location behind the vertical part 25 for illustration. The actual location may be elsewhere, for example within the cab of the forklift. It is understood the controller 17 should be protected from forces etc. that might damage the electronics within. The controller 17 may be connected to a display unit such as a computer screen, one or more signalling lamps or an alarm. The display unit may be mounted on any suitable location e.g. a dash board, the mast of the forklift etc.

FIG. 5a illustrates a front-tip of the fork 20 viewed from a side. The wear plate 13 is sectioned to show the sensor 11 within the recess 10. The sensor 11 is preferably an optical source and detection unit. Infrared radiation penetrates a layer of dust more easily than visible light, so an infrared sensor is less sensitive to dust. Hence, the optical sensor preferably operates in the infrared range.

If the sensor is an optical sensor in the visible or infrared spectrum, the cable 12 preferably comprises an optical fibre. Alternatively, the cable 12 might be a wire conducting electrical power to, for example, an LED-source. However, the detector part would need an opto-electric transformer and possibly an amplifier for an electric return signal. This would lead to a more bulky and complex design at the fork-tip than using an optical fibre and keep the electronics within the controller 17 (FIG. 4).

An ultrasound sensor would also probably need electronic components, e.g. an amplifier, at the fork-tip. Thus, an optical sensor 11 with an optical fibre 12 is preferred over an ultrasound sensor.

To facilitate manufacturing, the cable 12 may be glued to a surface, e.g. the recess in the wear plate 13 in FIGS. 1-3, or to the fork 20 in the second embodiment shown in FIGS. 4-7. A longitudinal groove 15 may be provided for the cable 12 in the fork 20 rather than in the wear plate 13. The purpose of such a groove 15 is to protect the cable 12, i.e. as the recess 10 in the first embodiment shown in FIGS. 1 and 2.

FIG. 5b shows a fork-tip similar to that in FIG. 5a. The difference is that the wear plate 13 extends under the fork 20. Welding a wear plate to the fork is useful to mend wear, and thus increases the working life, and reduces the operational costs, of the fork 20.

FIG. 6a shows a fork tip viewed from the side as in FIGS. 5a and 5b, but with a wear plate 13 at the top side of the fork 20. A main benefit of this embodiment is that the sensor 13 may be directed forward in the direction of the fork 20, i.e. to the left in FIG. 6a, and still be protected by the wear plate 13.

FIG. 6b is a top view of the embodiment in FIG. 6a. The wear plate 13 extends along the sides of sensor 13 to provide proper protection. The wear plate 13 may extend along part or all of the fork 20, and is preferably cut from a standard wear plate.

FIG. 7a is a front view of an embodiment wherein a wear plate 13 covers the front tip e.g. as illustrated in FIGS. 5a and 5b. The wear plate 13 has the same profile as the fork 20 with longitudinal grooves 15. The longitudinal grooves 15 are exaggerated and cable 12 is visible to illustrate embodiments with a longitudinal groove 15, e.g. milled into the fork 20, and a cable 12 arranged in the groove. The longitudinal groove 15 may be sufficiently deep to protect the cable 12, and a filling material, e.g. an epoxy resin, may replace a wear plate covering the groove 15. Obviously, a similar filler may be used in the recess 10 protecting the cable 12 in the first embodiment shown in FIGS. 1 and 2. The two grooves 15 in FIGS. 7a (and 7b) illustrates that separate grooves 15 may be provided for a source and a detector if desired. Similar recesses 10 may of course be provided in the wear plate 13 of the first embodiment.

FIG. 7b is similar to FIG. 7a, but with a rectangular wear plate 13 in front. The longitudinal grooves 15 and cable 12 are indicated by dotted lines.

While the invention has been described by means of examples, the full scope of the invention is defined by the following claims.

1-10. (canceled)

11. A protective device for a forklift having a fork, comprising:
a sensor at a front face of the fork;
a controller;
a cable running from the sensor along the fork to the controller; and
a wear plate attached to the fork configured to protect the sensor.

12. The protective device according to claim 11, wherein the wear plate is configured to cover an upper surface of the fork.

13. The protective device according to claim 12, wherein the wear plate is divided into several sections by lateral cuts.

14. The protective device according to claim 12, wherein the wear plate comprises a longitudinal recess adapted to enclose the sensor and cable.

15. The protective device according to claim 13, wherein the wear plate comprises a longitudinal recess adapted to enclose the sensor and cable.

16. The protective device according to claim 11, wherein the cable runs in a longitudinal groove in the fork.

17. The protective device according to claim 11, wherein the wear plate covers the cable.

18. The protective device according to claim 11, wherein the sensor is an optical source and detection unit.

19. The protective device according to claim 18, wherein the optical sensor operates in an infrared range.

20. The protective device according to claim 18, wherein the cable comprises an optical fibre.

21. The protective device according to claim 11, wherein the controller is connected to a display unit.

22. The protective device according to claim 11, wherein the controller is connected to a signalling lamp.

23. The protective device according to claim 11, wherein the controller is connected to an alarm.
